(19) United States
(12) Patent Application Publication
(10) Pub. No.: US 2005/0259982 A1
(43) Pub. Date: Nov. 24, 2005

(54) Stroboscopic flash regulator for a digital camera mount

(75) Inventor: Toshio Toya, Taitou-ku (JP)

Correspondence Address: PEARNE & GORDON LLP, 1801 EAST 9TH STREET, SUITE 1200, CLEVELAND, OH, 44114-3108, US

(73) Assignee: Sonictechno Co., Ltd.

(21) Appl. No.: 11/120,591

(22) Filed: May 3, 2005

(30) Foreign Application Priority Data
May 18, 2004 (JP) 2004-147236

(51) Int. Cl. G03B 15/06

(52) U.S. Cl. 396/199

(57) ABSTRACT

A stroboscopic flash regulator for a digital camera mount comprising a case on which a camera body of the digital camera is mounted, camera attachment means to removably attach the bottom of the camera body to the case, a stroboscopic flash regulator component disposed within the case to be connected to stroboscopic flash means which is in turn attached to the digital camera and an electric source disposed within the case to drive the stroboscopic flash unit through the stroboscopic flash regulator.

### TECHNICAL FIELD OF THE INVENTION

This invention relates to a stroboscopic flash regulator for driving a stroboscopic flash unit to be attached to a digital camera and more particularly to a stroboscopic flash regulator having an improvement on a disposition thereof.

### BACKGROUND OF THE INVENTION

The applicant discloses a digital camera comprising a ring-like stroboscopic flash unit attached on a front face of a lens cylindrical body of a camera body of a digital camera or a twin stroboscopic flash unit attached through a ring member on the front face of the lens cylindrical body and angularly moved in a rightward or leftward direction (see JP2001-356403 A and JP2002-122936 A).

In the digital camera having such a stroboscopic flash unit, a stroboscopic flash regulator is attached to an accessory shoe provided on a tope face of a camera body of the digital camera. The stroboscopic flash regulator and the stroboscopic flash unit are connected to each other by a connection cable.

A photographer who operates a camera sometimes directly checks a photographic object with its eyes while its eye moves apart from a finder of the camera during photographing various objects. With a stroboscopic flash regulator attached on a top of the camera, since the regulator extends longwise above the finder of the camera, the stroboscopic flash regulator gets obstructive so as to prevent the photographer from checking the photographic object when the photographer should check it directly with its naked eye while parting the eye from the finder of the camera.

### SUMMARY OF THE INVENTION

Accordingly, it is a principal object of the invention to provide a stroboscopic flash regulator for a digital camera mount adapted to be disposed so that the stroboscopic flash regulator never obstructs a photographer from checking a photographic object with its naked eyes while parting them from a finder of the camera.

In accordance with a feature of the invention, there is provided a stroboscopic flash regulator comprising a case on which a camera body of the digital camera is mounted, camera attachment means to removably attach the bottom of the camera body to the case, a stroboscopic flash regulator component disposed within the case to be connected to stroboscopic flash means which is in turn attached to the digital camera and an electric source disposed within the case to drive the stroboscopic flash unit through the stroboscopic flash regulator.

The camera attachment means of the stroboscopic flash regulator for the digital camera mount comprises a screw rod protruding from an upper face of the case to be engaged with a threaded hole in a bottom of the camera body and a knob for rotating the screw rod. The knob may be partially exposed through a slit in the case so as to be allowed from being operated from the outside of the case.

The stroboscopic flash regulator for the digital camera mount may further comprise a hot shoe adapter to be connected to a hot shoe of the camera body, and the hot shoe adapter may be connected to the stroboscopic flash regulator component through an electric cord.

In this manner, since the stroboscopic flash regulator is disposed within the case to be removably attached to the bottom of the camera body so as to mount the camera body thereon, but not on the top of the camera body of the digital camera, the stroboscopic flash regulator never obstructs a photographer from checking a photographic object with its naked eyes while parting from a finder of the camera whereby photographic objects can be more easily checked.

Also, an operation of attaching the camera body to the stroboscopic flash regulator can be easily performed only by rotating the knob exposed from a front face of the case as if a screw rod is engaged with a threaded hole normally provided in the bottom of the case for attaching it to a tripod for a camera and therefore, the attachment of the camera can be more easily made.

An electric synchronization of the stroboscopic flash regulator and the camera body can be easily done by connecting to a hot shoe of the camera body a shoe adapter extending from the case.

### BRIEF DESCRIPTION OF THE DRAWINGS

The above and other objects and features of the invention will be apparent from the detailed description of the preferred embodiment of the invention, which is described and illustrated with reference to the accompanying drawings, in which;

FIG. 1 is a perspective view of a digital camera having a stroboscopic flash regulator according to one embodiment form of the invention;

FIG. 2 is a perspective view of stroboscopic flash means used for the digital camera of FIG. 1 and a stroboscopic flash regulator connected to each other;

FIG. 3 is a perspective view of the stroboscopic flash means of FIG. 2 having its holder removed therefrom;

FIG. 4 is an enlarged upper face view of the stroboscopic flash regulator shown in FIGS. 1 through 3;

FIG. 5 is an enlarged front view of camera attachment means used for the stroboscopic flash regulator shown in FIGS. 1 through 3;

FIG. 6 is a perspective view of a digital camera having a stroboscopic flash regulator constructed in accordance with another embodiment form of the invention; and

FIG. 7 is a perspective view of stroboscopic flash means used for the digital camera of FIG. 6 and a stroboscopic flash regulator connected to each other.

### DETAILED DESCRIPTION OF PREFERRED EMBODIMENTS

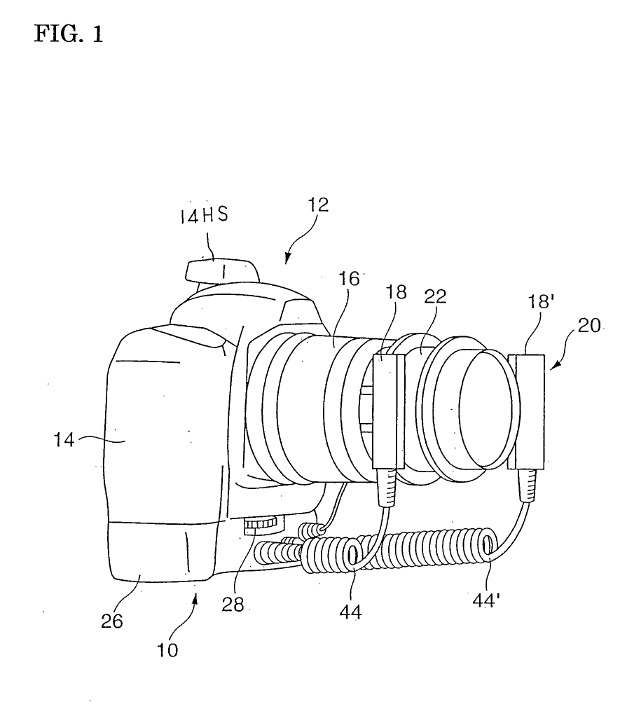

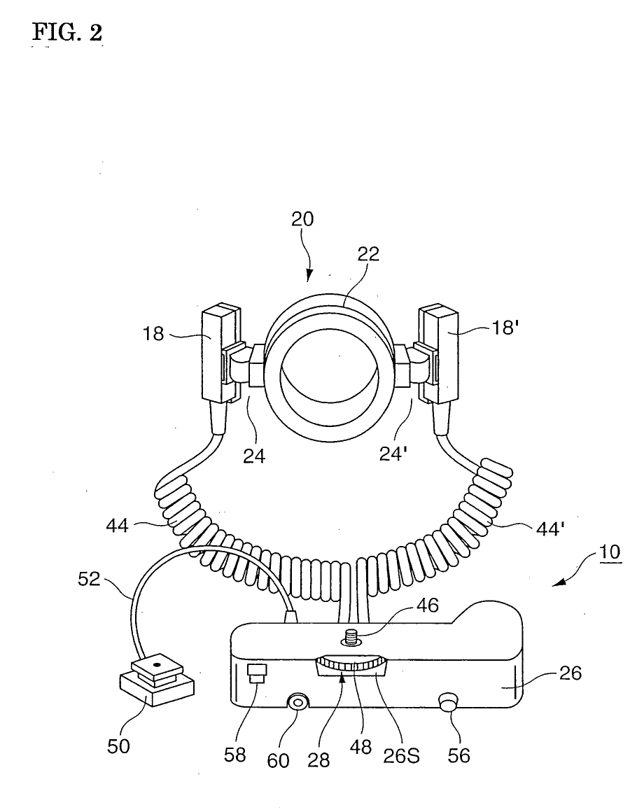

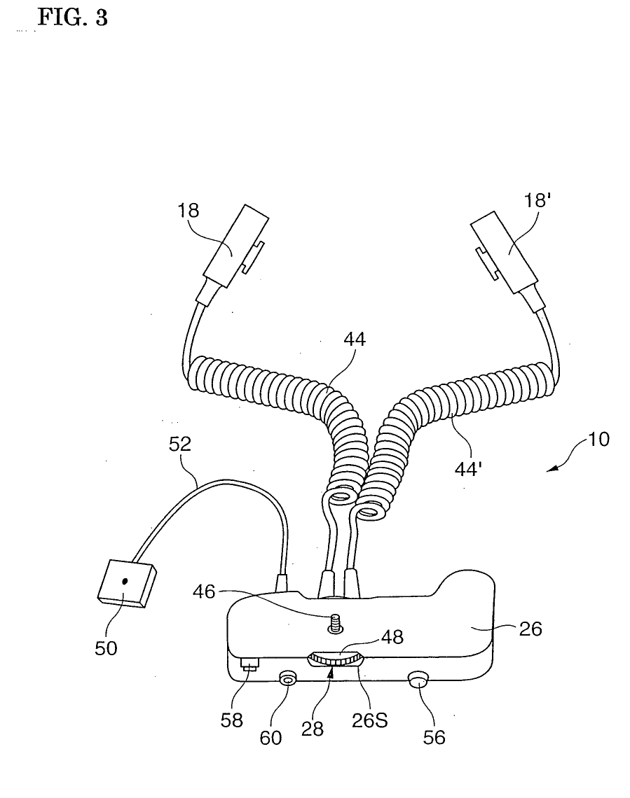

The invention will now be described with reference to accompanying drawings. FIGS. 1 through 3 illustrates a digital camera 12 having a stroboscopic flash regulator 10 for a digital camera mount constructed in accordance with one embodiment form of the invention.

In the illustrated embodiment, the digital camera 12 has stroboscopic flash means 20 including a plurality of stroboscopic flash units 18 and 18′ (two flashes in the illustrated embodiment) to emit light on both sides ahead of a lens cylinder 16 of a camera body 14 of the digital camera 12.

This stroboscopic flash means 20 comprises a ring-like stroboscopic flash holder 22 to be attached to the front of the lens cylinder 16 of the camera body 14 by appropriate means and stroboscopic flash holding means 24 and 24′ to removably hold the stroboscopic flash units 18 and 18′ on the ring-like stroboscope holder 22 to be angularly adjusted in rightward and leftward directions and in upward and downward directions.

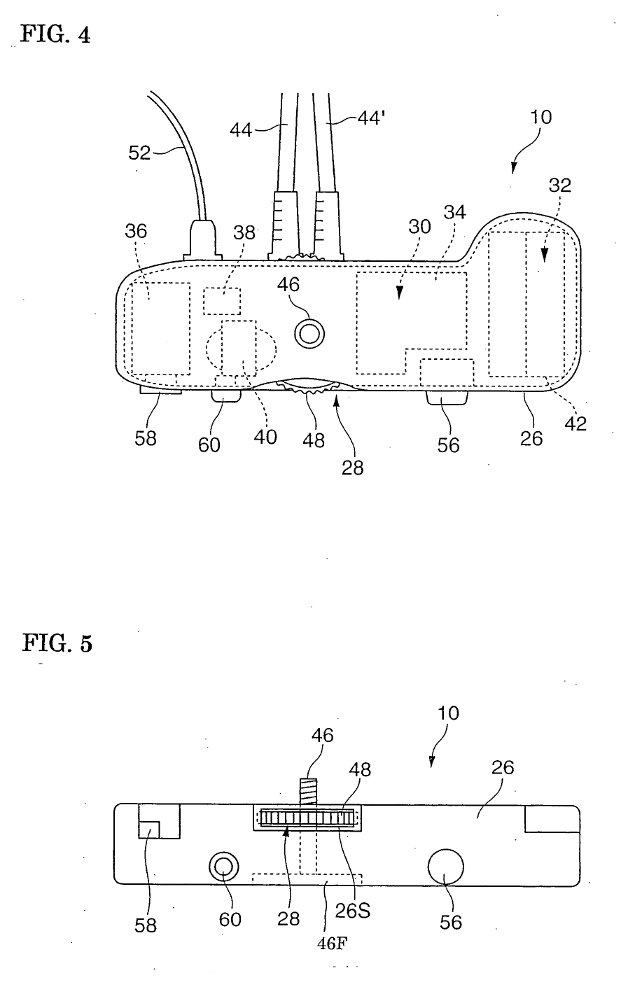

As shown in FIG. 4, the stroboscopic flash regulator 10 for the digital camera mount of the invention comprises a case 26 to mount the camera body 14 thereon, camera attachment means 28 to removably attach the bottom of the camera body 14 onto the case 26, a stroboscopic flash regulator component 30 disposed within the case 26 to be connected to the stroboscopic flash units 18 and 18′ and an electric source 32 disposed within the case 26 to drive the stroboscopic flash units 18 and 18′ through the stroboscopic flash regulator component 30.

The stroboscopic flash regulator component 30 comprises an IC circuit board 34 having a stroboscopic flash regulator circuit including a luminescence quantity adjustment circuit, a voltage rise prevention stabilization circuit and an electric source automatic disconnection circuit mounted thereon, a main condenser for a stroboscopic flash, a transformer, a stroboscopic flash triggering coil 40 and a battery container part 42 to removably contain a battery for the electric source 32. These elements are contained in the case 26 as shown in FIG. 4.

The voltage rise prevention stabilization circuit serves to prevent the voltage rise caused by voltage variation in accordance with the consumption of the battery so as to prevent the unstable luminescence quantity whereby the constant luminescence quantity can be obtained. The electric source automatic disconnection circuit serves to automatically disconnect the electric source when four minutes, for example elapses after the luminescence of the stroboscopic flash whereby the consumption of the battery can be prevented.

The stroboscopic flash regulator 10 includes two connection cables 44 and 44′ to supply the output of the regulator 10 to the stroboscopic flash units 18 and 18′, respectively and connected to output terminals (not shown) of the stroboscopic flash regulator 10 in a plug-like manner. Alternatively, the connection cables 44 and 44′ may be connected directly to the output terminals of the stroboscopic flash regulator 10, but not in the plug-like manner.

As shown in FIG. 5, the camera attachment means 28 comprises a screw rod 46 protruding from an upper face of the case 26 to be engaged with a threaded hole (for a photographic tripod) provided in the bottom of the camera body 14 in a threaded manner and a knob 48 for rotating the screw rod 46. The knob 48 may be partially exposed through a slit 26S in the case 26 between the front and rear faces of the case 26 so as to be manually operated outside of the case 26. The knob 48 is held by the upper and lower walls defining the slit 26S so as to be rotated, but not to be moved upwardly or downwardly.

Thus, after the digital camera 12 is mounted on the case 26 of the stroboscopic flash regulator 10 for the camera mount while the screw rod 46 aligns the threaded hole in the bottom of the digital camera 12 and as the screw rod 46 is rotated, it is thrust into the threaded hole in the camera body 14 in a threaded manner. As a flange 46F of the screw rod 46 is engaged against the inner face of the case 26, the camera body 14 is secured by the screw rod 46 to the case 26.

The stroboscopic flash regulator 10 for the digital camera mount further comprises a hot shoe adapter 50 to be connected to a hot shoe 14HS of the camera body 14. The hot shoe adapter 50 may be connected to the stroboscopic flash regulator component 30 through a connection electric cord 52 extending through the case 26 outside thereof.

In operation, the stroboscopic flash regulator 10 for the digital camera mount is used by mounting the camera body 14 on the case 26 thereof and rotating the knob 48 of the camera attachment means 28 to thereby secure the camera body 14 to the case 26. The stroboscopic flash units 18 and 18′ are set to the digital camera 12 by inserting the stroboscope connection cables 44 and 44′ into the output terminals of the stroboscopic flash regulator 10 and connecting to the hot shoe 14HS of the camera body 14 the hot shoe adapter 50 provided at the end of the connection cord 52 extending from the case 26.

When an object should be photographed with the digital camera 12, as the triggering coil 40 of the stroboscopic flash regulator component 30 is excited interlocking with a shutter of the digital camera 12 through the hot shoe 14HS, the hot shoe adapter 50 and the connection cord 52, the stroboscopic output drives the stroboscopic flash units 18 and 18′ through the stroboscope connection cables 44 and 44′ to thereby emit the stroboscopic light from the stroboscopic flash units.

In this manner, since the stroboscopic flash regulator 10 is secured not to the top of the camera body 14 of the digital camera 12, but to the bottom of the camera body 14 in a removable manner, when a photographer tries to check the photographic object directly with its naked eyes while its eyes move apart from the camera, the stroboscopic flash regulator never interrupts the filed of vision and therefore the photographer can positively check the photographic object.

Since the stroboscopic flash regulator 10 can be secured to the camera only by rotating the knob 48 so that the screw rod 46 is threadedly thrust into the threaded hole in the camera body 14 on the bottom thereof to be used for generally securing the photographic tripod.

In addition thereto, the stroboscopic flash regulator 10 and the camera body 16 can be electrically synchronized with each other by connecting the shoe adapter 50 with the hot shoe.

The stroboscopic flash regulator 10 may be preferably provided with an AC adapter jack 60, which may be used for supplying an AC electric source to the stroboscopic flash regulator to thereby drive it. In the figures, a reference numeral 56 designates a liminescence quantity adjustment dial and a reference numeral 58 designates an electric source switch.

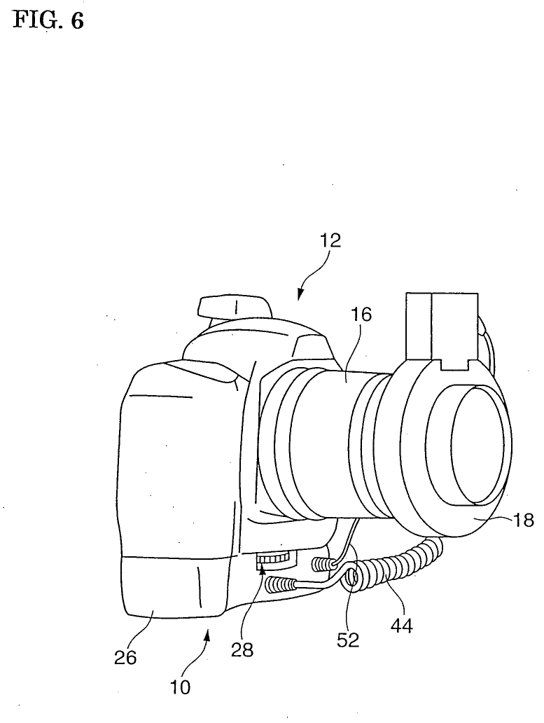

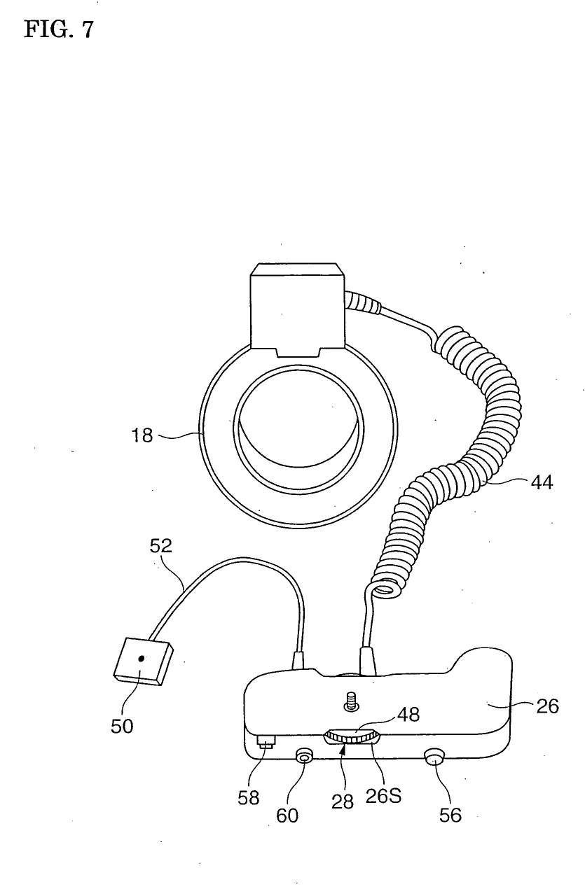

Another form of the invention in which the stroboscopic flash regulator 10 of the invention is applied to a ring-like stroboscopic flash unit is shown in FIGS. 6 and 7. Since the stroboscopic flash regulator of this form is substantially identical to that having the twin stroboscopic flash units except that a terminal of a single connection cable 44 extending from the ring-like stroboscopic flash unit 18 is connected to a single output terminal provided in the stroboscopic flash regulator 10, further detailed explanation will be omitted.

It will be understood that the stroboscopic flash regulator 10 of the invention may have a tripod attachment threaded hole provided in the bottom of thereof in the same manner as the tripod attachment threaded hole is provided in the bottom of the camera body. Thus, the tripod can be attached to the bottom of the stroboscopic flash regulator 10 by using the tripod attachment threaded hole in the stroboscopic flash regulator 10.

According to the invention, since the stroboscopic flash regulator is adapted to be attached to the bottom of the camera body so as to mount the camera body thereon, but not on the top of the camera body of the digital camera, the stroboscopic flash regulator never obstructs the photographer from checking the photographic object with its naked eyes while parting from the finder of the camera whereby the photographic objects can be more easily checked, which improves the availability on industries.

Although some preferred embodiments of the invention have been described and illustrated with reference to the accompanying drawings, it will be understood by those skilled in the art that they are by way of examples, and that various changes and modifications may be made without departing from the spirit and scope of the invention, which is d only to the appended claims.

1. A stroboscopic flash regulator for a digital camera mount comprising a case on which a camera body of said digital camera is to be mounted, camera attachment means to attach a bottom of said camera body to said case in a removable manner, a stroboscopic flash regulator component disposed within said case to be connected to stroboscopic flash means which is in turn to be attached to said digital camera and an electric source disposed within said case to drive said stroboscopic flash means through said stroboscopic flash regulator.

2. A stroboscopic flash regulator for a digital camera mount as set forth in claim 1, and wherein said camera attachment means comprises a screw rod protruding from an upper face of said case to be threadedly engaged with a threaded hole in a bottom wall of said camera body and a knob for rotating said screw rod and said knob is partially exposed through a slit in said case so as to be allowed from being operated outside of said case.

3. A stroboscopic flash regulator for a digital camera mount as set forth in claim 1, and further comprising a hot shoe adapter to be connected to a hot shoe of said camera body and connected to said stroboscopic flash regulator component through an electric cord.

4. A stroboscopic flash regulator for a digital camera mount as set forth in claim 2, and further comprising a hot shoe adapter to be connected to a hot shoe of said camera body and connected to said stroboscopic flash regulator component through an electric cord.
